(19) United States
(12) Patent Application Publication
(10) Pub. No.: US 2020/0282431 A1
(43) Pub. Date: Sep. 10, 2020

(54) ORE INTELLIGENCE SORTING APPARATUS AND METHOD BASED ON X-RAYS DISCERNMENT

(71) Applicant: LONGI MAGNET Co., Ltd., Fushun City, Liaoning (CN)

(72) Inventors: Chengchen ZHANG, Fushun City, Liaoning (CN); Zhaopeng LI, Fushun City, Liaoning (CN); Yulin SHI, Fushun City, Liaoning (CN); Shuangfu YANG, Fushun City, Liaoning (CN); Ximing LI, Fushun City, Liaoning (CN); Changfu JI, Fushun City, Liaoning (CN); Yang LIU, Fushun City, Liaoning (CN); Mingyuan FAN, Fushun City, Liaoning (CN); Yuzhu WANG, Fushun City, Liaoning (CN); Chunye XU, Fushun City, Liaoning (CN)

(21) Appl. No.: 15/751,855

(22) PCT Filed: Jun. 22, 2017
(86) PCT No.: PCT/CN2017/089507

§ 371 Date: May 6, 2020

(30) Foreign Application Priority Data
Mar. 28, 2017 (CN) 201710193752.8

(51) Int. Cl. B07C 5/346

(52) U.S. Cl. CPC B07C 5/346

(57) ABSTRACT

The ore intelligence sorting apparatus and method based on X-rays discernment includes a feeding unit with a toothed classifier, an X ray excitation unit with filter, a characteristic spectrum receiving unit with filter, a computer analysis and control unit with a central control unit, a spectral acquisition system, an industrial computer and an instruction output system, and a separator unit with a cylinder and a wear-resistant kick plate. The feeding unit is fed by a vibrating feeder and grading materials by a toothed classifier, and the measured ore is stimulated by the X ray excitation unit to produce a characteristic x ray spectra. The characteristic spectrum receiving unit receives the characteristic x ray spectrum which is then analyzed by the computer analysis and control unit, and a sorting instruction is output based on the analysis results. The invention is used for sorting magnetic or non-magnetic ores in a concentrator.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The invention belongs to the technical field of ore magnetic separation and specifically relates to an ore intelligence sorting apparatus and method based on X-rays discernment, which is a novel intelligent ore sorting equipment and is suitable for the determination and the simultaneous sorting of a plurality of useful components in ores.

### 2. Description of Related Art Including Information Disclosed Under 37 CFR 1.97 and 37 CFR 1.98

In the field of mineral sorting, because of the relatively large reserves of iron ore, coal mine and other minerals, it has been widely used in daily production and life, and it has made great progress in mineral sorting technology and mineral sorting equipment. Especially for iron ore, the domestic iron ore mineral processing and equipment have reached a very high standard because of the domestic ore characteristics of more poverty and less wealth, even in the world in a leading position. For rare heavy metals, precious metals, non-metallic minerals whose content being more rare and the distribution being more dispersed, there is no relatively uniform, flexible sorting device for sorting ore.

For an ore containing such valuable elements as copper, gold, silver, molybdenum, nickel, tungsten, lead, zinc, and vanadium, because of its relatively low content in the ore, It will greatly consume manpower, material and financial resources if the ore is directly feed into the crushing grinding stage. Therefore, the ore needs to be preselected. At present, for mineral species being not be sorted by magnetic separation, manual selection is the preferred mode of selection, but there are high separation costs, low efficiency, poor accuracy and so on in manual selection.

### BRIEF SUMMARY OF THE INVENTION

In order to solve the above problems, after the present inventor design and research, an ore intelligence sorting apparatus and method based on X-rays discernment is proposed. The technology based on X-rays is used to identify useful elements and their content in ore and is used to sort ore with different content of elements by a sorting unit and can detect and sort ore with multiple elements in a single device.

In accordance with the first aspect of the present invention, an ore intelligence sorting apparatus based on X-rays discernment is proposed which includes a feeding unit 1 with a toothed classifier 16, and a X ray excitation unit 5 with a filter 21, and a characteristic spectrum receiving unit 4 with a filter 19, and a computer analysis and control unit 6 with a central control unit 26, a spectral acquisition system 23, an industrial computer 24 and an instruction output system 25, and a separator unit 3 with a cylinder 10 and wear-resistant kick plate 9; the feeding unit is fed by a vibrating feeder, and materials is graded by means of a toothed classifier, and the measured ore is stimulated by the X ray excitation unit to produce a characteristic x ray spectra, and the characteristic spectrum receiving unit receives characteristic x ray spectrum which is then analyzed by the computer analysis and control unit, and a sorting instructions is output based on the analysis results to use for sorting magnetic or non-magnetic ores in a concentrator.

Preferably, the feeding unit 1 is composed of a feed box 13, a vibrating motor 14, a vibrating platform 17, a fine material passage 12, a fine material groove 15, a chute motor 18 and a chute 11; and the tooth of the toothed classifier 16 is cylindrical and the end of tooth is processed into a cone, and are disposed at the outlet of the vibrating platform 17 and disposed side by side in the direction of discharging material; the cone end of the tooth of the toothed classifier 16 is positioned at the outlet end in the direction of discharging material. The chute 11 is located at the cone end of the tooth of the toothed classifier 16, and an even number chute motor 18 is symmetrically arranged with a chute 11 as the center; and the chute 11 is of U shape, and the distributed material groove can be arranged as needed on the groove surface in the U groove of the chute.

Preferably, the computer analysis control unit 6, the X ray excitation unit 5 and the characteristic spectrum receiving unit 4 are encapsulated in the package case 2; the package case 2 is made of material that can shield X rays. The package case 2 is arranged directly below at the front of the chute 11 and the vertical distance (A dimension) is between 50 mm-230 mm; the horizontal distance (B dimension) from the front edge of the packing case 2 to the exit of the chute 11 is 0 mm-100 mm; the clockwise angle (6 angle) of the package case 2 and the horizontal plane is 0-600.

Further, the central control unit 26 is placed outside the device to transmit signals with the industrial computer 24 in the device via a cable or a wireless connection; one central control unit 26 can be connected with a plurality of industrial control computers 24 simultaneously. A wear-resistant kick plate 9 of the sorting unit 3 is arranged on a supporting rod extending out of the cylinder 10, and the wear-resistant kicking plate 9 is made of wear-resistant material or the wear-resistant kicking plate 9 is provided with wear-resistant material to increase the abrasion resistance.

Preferably, the X ray excitation unit 5 mainly comprises a X ray tube 22, a filter 21, a high-voltage power supply and a constant temperature and humidity device; X ray emitted by the X ray excitation unit 5 can be a point light source to send a circular irradiation region to the material, or send a transverse linear irradiation region; the filter 21 in the X ray excitation unit 5 is positioned between the ore to be measured and the X ray tube 22. The characteristic spectrum receiving unit 4 is composed of a characteristic spectrum receiving sensor 20 and a filter 19, and the filter 19 is between the ore and the characteristic spectrum receiving sensor 20.

In accordance with the second aspect of the present invention, a sorting method using ore intelligence sorting apparatus based on X-rays discernment is proposed which include the following steps:

Step 1, the operator set the corresponding sorting parameters on the basis of the local environmental characteristics, the elements distribution characteristics of an ore to be sorted in the central control unit 26 in a central control room 26, and the parameters are transmitted to the industrial computer 24 by wire or wireless;

Step 2, after the industrial computer 24 receives the sorting parameter set by the central control unit 26, the X ray excitation unit 5 and the characteristic spectrum receiving unit 4 and the feeding unit 1 are opened, and the sorting equipment begin to work;

Step 3, when the ore to be sorted and supplied through the feeding unit 1 falls into the radiation range of the X ray excitation unit 5, the ore is excited by the X ray excitation unit 5 to produce a characteristic spectrum;

Step 4, a characteristic spectral receiving unit 4 receives a characteristic spectra generated by the ore and inputs the characteristic spectrum to the spectral acquisition system 23;

Step 5, the characteristic spectrum is transmitted to the industrial computer 24 after being processed by the spectral acquisition system 23 again, and the industrial computer 24 compares the spectral signals with the sorting parameters transmitted by the central control unit 26 in Step 1, and finally obtains the sorting instructions, and the sorting instruction is output to the sorting unit 3 through the instruction output system 25;

Step 6, the sorting unit 3 executes the sorting instruction after receiving the sorting instruction, and finally completes one sorting;

Step 7, cycling Step 3 to Step 6.

The invention relates to ore intelligence sorting apparatus and method based on X-rays discernment, and it has the advantages of simple structure and reasonable design, and fills the blank of such ore sorting, and is worth popularizing and applying widely. And using ore intelligence sorting apparatus and method, only a single set of equipment can used instead of hand sorting to select target metals, non-metallic minerals, and other rare minerals, then the ore is preselected which isn't preselected in the magnetic separation, and a large number of low-grade or unqualified waste is discarded ahead of time to reduce processing costs, improve processing efficiency and stability of the subsequent ore separation grade.

### BRIEF DESCRIPTION OF THE SEVERAL VIEWS OF THE DRAWINGS

FIG. 1 is a schematic view of a diagram of an intelligent ore sorting device based on X ray identification in accordance with the present invention.

FIG. 2 is a schematic view of a diagram of the package structure of an intelligent ore sorting equipment based on X ray identification.

FIG. 3 is a schematic view of a first structure schematic diagram 1 of the feeding unit of an intelligent ore sorting equipment based on X ray identification.

FIG. 4 is a schematic view of a second structure schematic diagram 2 of the feeding unit of an intelligent ore sorting equipment based on X ray identification.

FIG. 5 is a structural schematic view of a diagram of the characteristic spectrum receiving unit of an intelligent ore sorting equipment based on X ray identification.

FIG. 6 is a structural schematic view of a diagram of the X ray excitation unit of an intelligent ore sorting equipment based on X ray identification.

FIG. 7 is a structural schematic view of a diagram of the computer analysis control unit of an intelligent ore sorting equipment based on X ray identification.

FIG. 8 is a structural schematic view of a diagram of the sorting unit of an intelligent ore sorting equipment based on X ray identification.

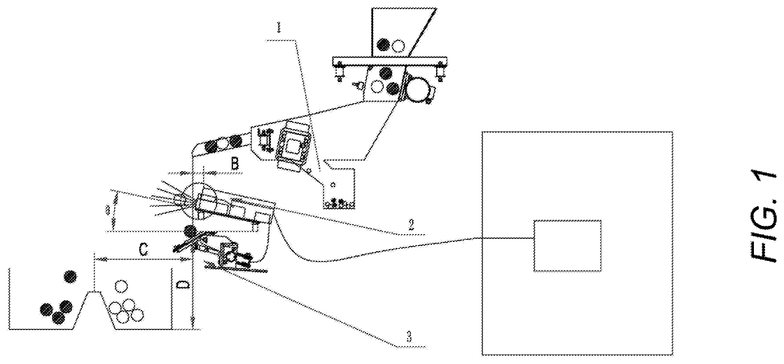

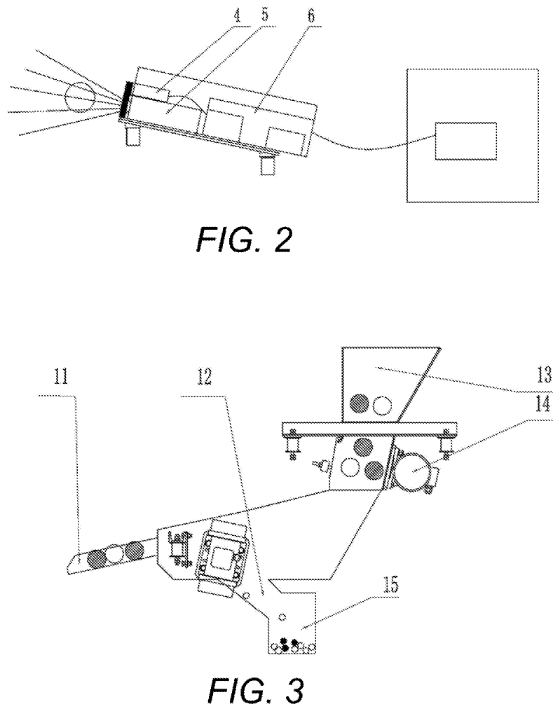

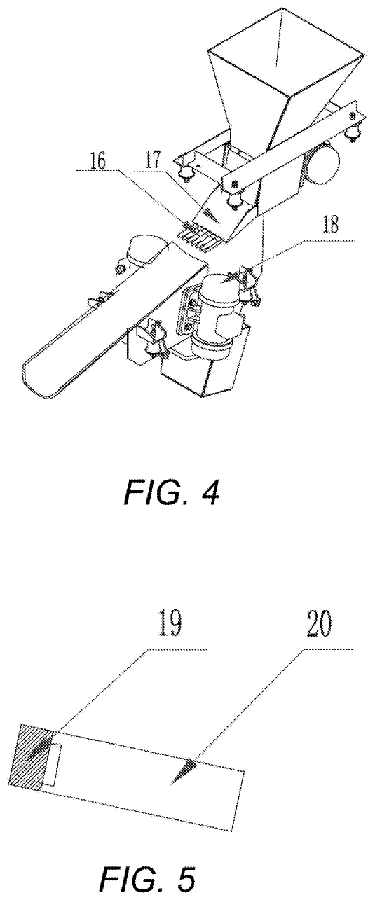

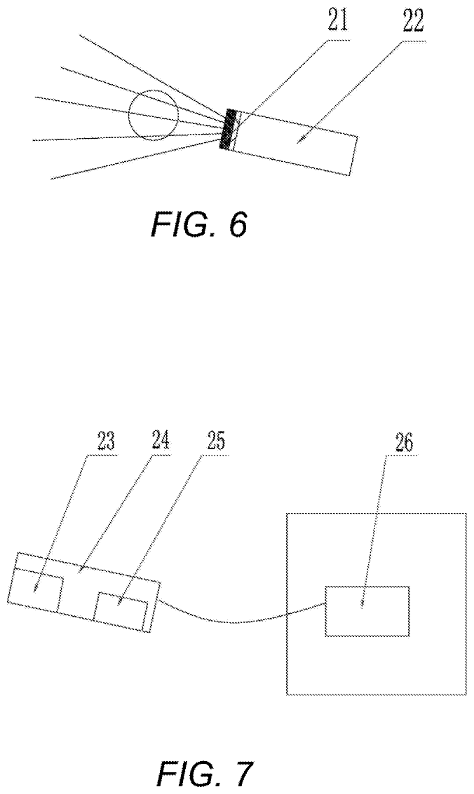

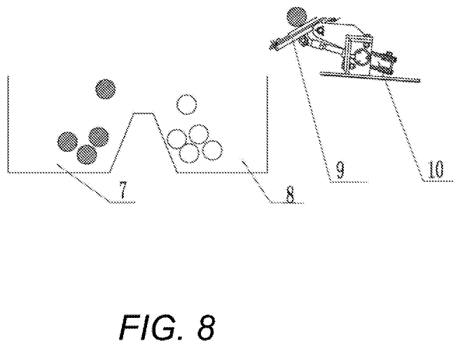

### DETAILED DESCRIPTION OF THE INVENTION

The technical solution in embodiments of the present invention is clearly and completely described below with reference to drawings in the embodiments of the present invention. Obviously, the described embodiments are only a portion of embodiments in the present invention but not all the embodiments of the present invention. Based on the embodiments in the present invention, an ordinary person skilled in the art can obtain all other embodiments without involving any inventive effort, which all shall fall within the protective scope of the present invention. Besides, the protective scope of the present invention should not be regarded as limit in the following specific structures or specific parameters.

The intelligent ore sorting device and method based on X ray identification in this invention, which is a X ray ore preselection machine that uses X ray fluorescence or diffraction principle to distinguish useful components and their contents; a device for detecting and sorting a plurality of elements on a single device is provided, which mainly includes a feeding unit, a X ray excitation unit, a characteristic spectrum receiving unit, a computer analysis and control unit and a sorting unit, and the units are interrelated and form a unified whole. The feeding unit is fed by a vibrating feeder, and the material is graded through a toothed classifier; the X ray excitation unit provides the X ray excitation source to the system through the X ray tube, and the X ray is selected suitable for energy through the filter; the characteristic spectrum receiving unit receives the characteristic spectrum through the characteristic spectrum receiving sensor; the computer control unit collects the characteristic spectrum through the spectral acquisition system, and the spectral signals are analyzed by an industrial computer, the sorting instruction is output by command output system; and using a wear-resistant kick plate, an electromagnetic push rod or a nozzle to sort ore in the sorting unit; the workflow is as follows: the feeding unit provides material for the sorting machine, and X ray excitation unit encourages the ore to be measured to produce characteristic x ray spectrum, and the characteristic spectral receiving unit then receives a characteristic x ray spectrum, and the computer analysis and control unit analyzes the spectrum and output the sorting instructions based on the analysis results. Finally, the sorting instruction is executed by the sorting unit. The invention can be used for sorting magnetic or non-magnetic ore in a concentrator, and has the advantages of high product range, high recovery rate, large amount of treatment, low water consumption and high automation degree.

In the present invention, the X ray is a kind of electromagnetic wave with extremely short wavelength and large energy, which has strong fluorescence effect and diffraction effect in crystal. The ore recognition principle used in the invention is as follows: the fluorescence action or diffraction action of X ray is used to identify different substances, and X ray is used to determine the content of useful elements in Ores during ore preselection stage.

In the present invention, a X ray ore preselected machine is provided that uses X ray fluorescence to identify useful components and their contents. The equipment of the invention mainly comprises includes a feeding unit 1 with a toothed classifier 16, and a X ray excitation unit 5 with a filter 21, and a characteristic spectrum receiving unit 4 with a filter 19, and a computer analysis and control unit 6 with a central control unit 26, a spectral acquisition system 23, an industrial computer 24 and an instruction output system 25, and a separator unit 3 with a cylinder 10 and wear-resistant kick plate 9; the feeding unit is fed by a vibrating feeder, and materials is graded by means of a toothed classifier, and the measured ore is stimulated by the X ray excitation unit to produce a characteristic x ray spectra, and the characteristic spectrum receiving unit receives characteristic x ray spectrum which is then analyzed by the computer analysis and control unit, and a sorting instructions is output based on the analysis results to use for sorting magnetic or non-magnetic ores in a concentrator.

The feeding unit is composed of a feed box, a vibrating motor, a vibrating platform, a toothed classifier, a fine material passage, a fine material groove, a chute motor and a chute, so as to provide a stable feeding state for the equipment. The X ray excitation unit consists of a X ray source, a high voltage power supply, a filter, and a constant temperature and humidity apparatus, so as to emit stimulated X rays to the ore to be measured; and the characteristic spectrum receiving unit is composed of a characteristic spectrum receiving sensor and a filter, which is used for receiving the characteristic spectrum released by the stimulated X ray of the ore to be measured; the computer analysis and control unit is composed of an industrial computer, a central control unit, a spectrum acquisition system and an instruction output system. It is used to analyze the spectrum received by the sensor, and then output the sorting instructions to the sorting unit. The sorting unit is mainly composed of a cylinder, a wear-resistant kick plate and a fine tailings distributor, so as to perform the sorting instructions produced by the computer analysis and control unit, and then sort the ore to be measured.

Further, the feeding bin of the feeding unit is a trapezoidal bucket which is of big top and small bottom, and a counterweight door is installed at one side of the lower part of feeding bin, and the counterweight is regulated by a thread. The feeding bin is positioned at the top of the electromagnetic vibration feeder and the electromagnetic vibration feeder is connected with the chute. The trough of the chute is a U chute, which ensures that the ore is capable of forming a row of ore streams that are fed into the sensor section of the characteristic spectral receiving unit. There is spacing strip-shaped projection between the inner walls of the chute. According to the processing capacity, the number of chute can be more than 1. The chute has a certain angle with the horizontal direction, and the angle is adjustable. The spring support is arranged between the chute and the frame body. The discharge port of the chute is located on the upper side of the characteristic spectrum receiving unit, and the ore can pass through the sensor of the characteristic spectrum receiving unit just after falling from the chute.

The characteristic spectrum receiving unit is positioned at the lower part of the chute of the feeding unit and is composed of a characteristic spectrum receiving sensor and a filter, wherein the filter is covered on the sensor window. The characteristic spectrum receiving sensor can discriminate a plurality of elements, and the invention can classify a plurality of elements by setting parameters, and the sorting accuracy is high and the efficiency is high. In addition, the characteristic spectral receiving unit can distinguish the ores by X ray fluorescence or X ray diffraction and the like, and the two identification methods correspond to the characteristic spectral receiving units.

The X ray excitation unit is positioned below the characteristic spectrum receiving unit, and is arranged in the same box body with the computer analysis and control unit, and the box body is supported on the bracket by the spring, and in the X ray excitation unit, X rays is first emitted by a X ray tube, and then the filter selects the appropriate energy or wavelength of the X ray to stimulate the ore to be selected according to the characteristics of the ore element to be selected.

The sorting unit is located at the lower part of the box bracket, and mainly composed of a cylinder, an wear-resistant kick plate, a concentrate and tailings separating tank. The sorting instructions of the calculation and analysis separate a mineral with a high content of useful elements and waste rock in the ore by the action of the sorting mechanism. The fine tailing chute is composed of a concentrate receiving tank and a waste rock receiving tank to use for receiving concentrates and waste rock after sorting of raw ore. Wherein the concentrate receiving tank is positioned on the side of the ore containing the element, and whose ore fall through the sorting mechanism and is separated into two falling paths. The waste rock receiving tank is positioned below one side of the waste rock falling. Furthermore, the chute in the feeding unit can also be a flat plate chute, and the chute is provided with a transverse bar shaped bulge. In addition, the sorting mechanism of the sorting unit can also be one or several combinations of a pneumatic kicking board, an electromagnetic kick board, or a jet blowing nozzle, which can be used to change the path of ore falling to separate waste rock and useful minerals.

In summary, the technology of the invention makes the ore from the feeding unit distributing material, and makes ore to be selected release the characteristic spectrum of the ore element which is stimulated by a X ray excitation source, and then the data is passed to the calculation and analysis control unit after the characteristic spectrum receiving unit receives characteristic spectrum of the ore to be measured and the internal data processor performs preliminary processing of the data, and the calculation and analysis control unit calculates the action signal. The sorting mechanism of sorting unit receives the action signal and then performs the sorting operation, separating the waste rock and the ore with high content of the useful elements into two falling paths. The waste rock and the ore with high content of useful elements fall apart and fall into the waste rock receiving tank and the concentrate receiving tank respectively to achieve the purpose of sorting.

The invention is illustrated in conjunction with the drawings below, a X ray ore preselected machine is provided that uses X ray fluorescence to identify useful components and their contents in the present invention which mainly includes the feeding unit 1 with feeding speed adjustable and feed particle size grading, the characteristic spectrum receiving unit 4 which can convert characteristic spectral signals into electrical signals, the sorting unit 3 using a cylinder 10 push the wear-resistant kick plate 9, and the computer analysis control unit 6 which can analyze rapidly the signal provided by the characteristic spectrum receiving unit 4 and make a quick response according to the user's setting threshold.

Wherein, the feeding unit 1 is composed of a feed box 13, a vibrating motor 14, a vibrating platform 17, a tooth classifier 16, a fine material passage 12, a fine material groove 15, a chute motor 18 and a chute 11, which is used to provide a stable feeding state of equipment. The feed box 13 is positioned at the top of the feeding unit 1 and is the feed port of the sorting machine, the vibrating motor 14 is positioned at the rear side of the feed box 13 to adjust feed rate, the vibrating platform 17 is connected with the outlet of the feed box 13 and is used to distribute material for the sorting machine. The tooth classifier 16 is connected with the end of the vibration platform 17, the lower part of the tooth classifier 16 is a fine material passage 12 and the bottom of the channel is a fine groove 15, the tooth classifier 16 is a cylindrical rod side-by-side and the end of the cylindrical rod is shaped into a taped cone, the chute 11 is along the direction of feeding and the side of the taped cone, even numbers chute motors 18 are installed on both sides of the center of the chute 11 to adjust the feeding speed of the chute 11. The feeding bin 13 is a trapezoidal bucket which is of big top and small bottom, and a counterweight door is installed at one side of the lower part, and the counterweight is regulated by a thread.

The tooth shape classifier 16 is mainly composed of a toothed column rod, wherein the cylinder connected with the vibrating platform 17 is cylindrical, and the end is conic. The conical end is at the outlet end of the discharge direction. According to the particle size of the equipment sorting materials, 4-50 tooth classifier 16 are arranged side by side at the exit of the vibrating platform 17 and arranged in the direction of the discharge. The utility model has the function of sieving the ore particles. The fine material is discharged through the fine material passage 12 and the fine material trough 7, both of which are arranged at the bottom of the toothed classifier 16 and have the function of recovering fine materials. The chute motor 18 and the chute 11 are positioned under the slope of the tooth classifier 16, and the utility model has the function of evenly distributing the ore in a plurality of sorting channels and regulating the speed of the classification ore feeding. The chute 11 is positioned at one end of the cone of the tooth classifier 16, and the chute 11 is symmetrically arranged with an even number of chute motors 18, and the chute is of a U shape, and a projection can be arranged according to the distributed material condition.

The characteristic spectral reception unit 4, the X ray excitation unit 5, and the computer analysis control unit 6 (excluding the central control unit) are packaged together by the same cabinet. The material can be shielded X ray radiation. Package box 2 between the chute 11 just below the vertical distance A size 50 mm-230 mm, horizontal distance B size is between 0 mm-50 mm, the package box 2 and the horizontal plane clockwise angle is 0-60 degrees, X ray stimulating unit 5 and the horizontal plane clockwise angle, θ angle is 0-22 degrees. The center horizontal distance of wear-resisting boot plate 9 of the sorting unit 3 from the concentrate and tailings separating mechanism C is 300 mm-1000 mm, the vertical distance is D, and the dimension is 500 mm-1200 mm.

Further, the characteristic spectral reception unit 4 may discriminate the ore by means of X ray fluorescence and X ray diffraction, and the two types of discrimination correspond to the characteristic ray receiving units, which are different embodiments. X ray fluorescence spectrum by the receiving unit 4 is composed by receiving sensor 20 and filter 19, it locates in the chute 11 below, has received the characteristic spectrum, and the spectral signals were converted to digital signal processing computer recognition, and Filter 19 is between the ore and the characteristic light ray receiving sensor 20.

X-ray unit 5 includes X ray tube 22, filter 21, high voltage power supply. Filter 21 is between ore and X ray tube 22, located in the spectral receiving unit 4 is used to characteristics of X-ray ore elements. The X ray excitation source 5 can be a point light source, which sends a circular irradiation region to the material, and a transverse linear irradiation region can also be sent out. The circular irradiation region is aligned with a channel and can be irradiated individually for an ore. The linear irradiation section allows transverse irradiation of all material falling from the ordinary vibratory feeder.

Sorting mechanism for sorting unit 3 can be pneumatic electromagnetic kick plate. One or several plates or high pressure gas nozzle, which can be used to change the path to separate the waste rock and ore are useful mineral role. The pneumatic kick plate sorting mechanism is composed of cylinder 10 and wear-resistant kick plate 9, which is arranged below the X ray exciting unit 5 and has an executing mechanism for performing sorting commands in real time. The electromagnetic kick plate sorting mechanism is composed of an electromagnetic push rod and a wear-resistant kick plate 9, the position and the function are the same as the pneumatic kick plate. The high pressure gas nozzle sorting mechanism is composed of a high pressure nozzle and a control electromagnetic valve. The position and the function are the same as that of the pneumatic kick plate. The wear-resisting kick plate 9 of the sorting unit 3 is arranged on the supporting rod extended out of the cylinder 10, and the wear-resistant kick plate 9 is made of wear-resistant material or is provided with wear-resistant material in the wear-resistant kicking plate 9 to increase the abrasion resistance.

The computer analysis control unit 6 is composed of an industrial control computer 24, a spectrum acquisition system 23 and an instruction output system 25 and is packaged in a box with a X ray excitation unit 5. An insulating spring is arranged between the package box 2 and the frame body to achieve buffer vibration and insulation with the frame body, and another central control machine 26 is placed in the central control room, which is used to set the sorting parameters and monitor the running state of the sorting machine in real time. Each central control machine 26 can be connected with a plurality of industrial control computers at the same time and can be connected by a cable or wireless connection. The central control machine 26 is placed outside the device and connected with the industrial control computer 24 in the device through the network cable, transmitting signals or transmitting signals through a wireless connection. A central control machine 26 can be connected with a plurality of industrial computer 24 at the same time.

The sorting method using the said intelligent ore sorting equipment based on the X ray identification is as follows:

Step 1, the operator set the corresponding sorting parameters on the basis of the local environmental characteristics, the elements distribution characteristics of an ore to be sorted in the central control unit 26 in a central control room 26, and the parameters are transmitted to the industrial computer 24 by wire or wireless;

Step 2, after the industrial computer 24 receives the sorting parameter set by the central control unit 26, the X ray excitation unit 5 and the characteristic spectrum receiving unit 4 and the feeding unit 1 are opened, and the sorting equipment begin to work;

Step 3, when the ore to be sorted and supplied through the feeding unit 1 falls into the radiation range of the X ray excitation unit 5, the ore is excited by the X ray excitation unit 5 to produce a characteristic spectrum;

Step 4, a characteristic spectral receiving unit 4 receives a characteristic spectra generated by the ore and inputs the characteristic spectrum to the spectral acquisition system 23;

Step 5, the characteristic spectrum is transmitted to the industrial computer 24 after being processed by the spectral acquisition system 23 again, and the industrial computer 24 compares the spectral signals with the sorting parameters transmitted by the central control unit 26 in Step 1, and finally obtains the sorting instructions, and the sorting instruction is output to the sorting unit 3 through the instruction output system 2;

Step 6, the sorting unit 3 executes the sorting instruction after receiving the sorting instruction, and finally completes one sorting;

Step 7, cycling Step 3 to Step 6.

Furthermore, the equipment disclosed by the invention can be combined, that is, according to the process parameters or performance requirements used in the field, the sets of equipment used in series, the first sets of equipment as a pre-roughing, the second sets of equipment in series with the first set of equipment for roughing, and third sets of equipment for fine sorting and so on, and then form a complete set of sorting equipment string.

The invention has the advantages of reasonable and novel structure, high safety, energy saving and beautiful appearance, while ensuring the good separation index. The above is only preferred specific embodiments of the invention; however, the scope of protection of the invention is not limited to this. Any modification or substitution that is easy to conceive by a person skilled in the art within the technical scope disclosed in the invention should be included in the scope of protection of the invention. It should be understood by an ordinary person in the art that any variety of modification could be made in format and detail without departing from the spirit and scope of the invention defined by the appended claims.

1. An ore intelligence sorting apparatus based on X-rays discernment comprises:
a feeding unit with a toothed classifier, and
an X ray excitation unit with a filter and
a characteristic spectral receiving unit with a filter used in receiving a characteristic X ray spectra fluorescence generated by the ore, and a computer analysis and control unit with a central control unit, a spectral acquisition system, an industrial computer and an instruction output system, and a separator unit with a cylinder and wear-resistant kick plate;
wherein the feeding unit is fed by a vibrating feeder, and materials is graded by means of a toothed classifier, and
wherein the measured ore is stimulated by the X ray excitation unit to produce a characteristic x ray spectra, and
wherein the characteristic spectrum receiving unit receives characteristic x ray spectrum which is then analyzed by the computer analysis and control unit, and a sorting instructions is output based on the analysis results to use for sorting magnetic or non-magnetic ores in a concentrator,
wherein a wear-resistant kick plate of the sorting unit is arranged on a supporting rod extending out of the cylinder and the wear-resistant kicking plate is comprised of wear-resistant material or the wear-resistant kicking plate is provided with wear-resistant material to increase the abrasion resistance;
wherein the characteristic spectrum receiving unit is comprised of a characteristic spectrum receiving sensor and a filter, and the filter is between the ore and the characteristic spectrum receiving sensor.

2. The ore intelligence sorting apparatus based on X-rays discernment of claim 1, wherein the feeding unit is comprised of a feed box, a vibrating motor, a vibrating platform, a fine material passage, a fine material groove, a chute motor and a chute;
wherein the tooth of the toothed classifier is cylindrical and the end of tooth is processed into a cone, and the toothed classifier are disposed at the outlet of the vibrating platform and disposed side by side in the direction of discharging material; the cone end of the tooth of the toothed classifier is positioned at the outlet end in the direction of discharging material.

3. The ore intelligence sorting apparatus based on X-rays discernment of claim 2, wherein the chute is located at the cone end of the tooth of the toothed classifier, and an even number chute motor is symmetrically arranged with a chute as the center; and the chute is of U shape, and the distributed material groove can be arranged as needed on the groove surface in the U groove of the chute.

4. The ore intelligence sorting apparatus based on X-rays discernment of claim 1, wherein the computer analysis control unit, the X ray excitation unit and the characteristic spectrum receiving unit are encapsulated in the package case; and wherein the package case is comprised of material that can shield X rays.

5. The ore intelligence sorting apparatus based on X-rays discernment of claim 4, wherein the package case is arranged directly below at the front of the chute and the vertical distance is between 50 mm-230 mm; wherein the horizontal distance from the front edge of the packing case to the exit of the chute is 0 mm-100 mm; and wherein the clockwise angle of the package case and the horizontal plane is 0-60°.

6. The ore intelligence sorting apparatus based on X-rays discernment of claim 1, wherein the central control unit is placed outside the device to transmit signals with the industrial computer in the device via a cable or a wireless connection; and wherein one central control unit connects with a plurality of industrial control computers simultaneously.

7. (canceled)

8. The ore intelligence sorting apparatus based on X-rays discernment of claim 1, wherein the X ray excitation unit comprises a X ray tube, a filter, a high-voltage power supply and a constant temperature and humidity device;
wherein the X ray emitted by the X ray excitation unit can be a point light source to send a circular irradiation region to the material or send a transverse linear irradiation region; and
wherein the filter in the X ray excitation unit is positioned between the ore to be measured and the X ray tube.

9. (canceled)

10. A sorting method for using the ore intelligent sorting equipment based on X ray identification claimed in claim 1, comprising the following steps:
Step 1, the operator set the corresponding sorting parameters on the basis of the local environmental characteristics, the elements distribution characteristics of an ore to be sorted in the central control unit in a central control room, and the parameters are transmitted to the industrial computer by wire or wireless;
Step 2, after the industrial computer receives the sorting parameter set by the central control unit, the X ray excitation unit and the characteristic spectrum receiving unit and the feeding unit are opened, and the sorting equipment begin to work;
Step 3, when the ore to be sorted and supplied through the feeding unit falls into the radiation range of the X ray excitation unit, the ore is excited by the X ray excitation unit to produce a characteristic spectrum;
Step 4, a characteristic spectral receiving unit receives a characteristic spectra generated by the ore and inputs the characteristic spectrum to the spectral acquisition system;
Step 5, the characteristic spectrum is transmitted to the industrial computer after being processed by the spectral acquisition system again, and the industrial computer compares the spectral signals with the sorting parameters transmitted by the central control unit in Step 1, and finally obtains the sorting instructions, and the sorting instruction is output to the sorting unit through the instruction output system;
Step 6, the sorting unit executes the sorting instruction after receiving the sorting instruction, and finally completes one sorting;
Step 7, cycling Step 3 to Step 6.
